(19) United States
(12) Patent Application Publication
(10) Pub. No.: US 2017/0264141 A1
(43) Pub. Date: Sep. 14, 2017

(54) METHOD AND APPARATUS FOR ADAPTING WIRELESS POWER TRANSFER BETWEEN WIRELESS POWER PROTOCOLS

(71) Applicant: QUALCOMM Incorporated, San Diego, CA (US)

(72) Inventor: William Henry Von Novak, III, San Diego, CA (US)

(21) Appl. No.: 15/065,464

(22) Filed: Mar. 9, 2016

(51) Int. Cl. H02J 50/12; H02J 7/02; H02J 50/90

(52) U.S. Cl. CPC H02J 50/12; H02J 50/90; H02J 7/025

(57) ABSTRACT

A wireless power transfer adapter is provided. The wireless power transfer adapter comprises a receive coil configured to receive wireless power from a wireless power transmitter at a first frequency associated with a first wireless power protocol of a plurality of wireless power protocols. The wireless power transfer adapter comprises a rectifier circuit configured to convert the wireless power received by the receive coil from the first frequency to a second frequency associated with a second wireless power protocol of the plurality of wireless power protocols that is different from the first protocol. The wireless power transfer adapter comprises a transmit coil configured to transmit at least some of the wireless power to a wireless power receiver at the second frequency and according to the second wireless power protocol.

### FIELD

This application is generally related to wireless transfer of charging power, and more specifically to methods and apparatus for adapting wireless power transfer between wireless power protocols.

### BACKGROUND

As wireless power evolves, wireless power protocols emerge that govern operation of the wireless power systems. These protocols address issues like field strengths, frequency of operation, turn on and turn off protocols, communication, device detection and the like. Standardization of wireless power leads to faster adoption and a more healthy ecosystem for wireless power, since designers have protocols they can design to and have some assurance of correct operation with other similarly designed devices. Thus, methods and apparatuses for adapting wireless power transfer between wireless power protocols are desirable.

### SUMMARY

In some implementations, a wireless power transfer adapter is provided. The wireless power transfer adapter comprises a receive coil configured to receive wireless power from a wireless power transmitter at a first frequency associated with a first wireless power protocol of a plurality of wireless power protocols. The wireless power transfer adapter comprises a rectifier circuit configured to convert the wireless power received by the receive coil from the first frequency to a second frequency associated with a second wireless power protocol of the plurality of wireless power protocols that is different from the first protocol. The wireless power transfer adapter comprises a transmit coil configured to transmit at least some of the wireless power to a wireless power receiver at the second frequency and according to the second wireless power protocol.

In some other implementations, a method for wireless power transfer is provided. The method comprises receiving wireless power from a wireless power transmitter at a first frequency associated with a first wireless power protocol of a plurality of wireless power protocols. The method further comprises converting the wireless power received from the first frequency to a second frequency associated with a second wireless power protocol of the plurality of wireless power protocols that is different from the first protocol. The method further comprises transmitting at least some of the wireless power to a wireless power receiver at the second frequency and according to the second wireless power protocol.

In yet other implementations, a non-transitory, computer-readable medium comprising code is provided. The code, when executed, causes a wireless power transfer adapter to receive wireless power from a wireless power transmitter at a first frequency associated with a first wireless power protocol of a plurality of wireless power protocols. The code, when executed, further causes the wireless power transfer adapter to convert the wireless power received from the first frequency to a second frequency associated with a second wireless power protocol of the plurality of wireless power protocols that is different from the first protocol. The code, when executed, further causes the wireless power transfer adapter to transmit at least some of the wireless power to a wireless power receiver at the second frequency and according to the second wireless power protocol.

In yet other implementations, a wireless power transfer adapter is provided. The wireless power transfer adapter comprises means for receiving wireless power from a wireless power transmitter at a first frequency associated with a first wireless power protocol of a plurality of wireless power protocols. The wireless power transfer adapter comprises means for converting the wireless power received from the wireless power transmitter from the first frequency to a second frequency associated with a second wireless power protocol of the plurality of wireless power protocols that is different from the first protocol. The wireless power transfer adapter comprises means for transmitting at least some of the wireless power to a wireless power receiver at the second frequency and according to the second wireless power protocol.

### BRIEF DESCRIPTION OF THE DRAWINGS

FIG. 1 is a functional block diagram of a wireless power transfer system, in accordance with some exemplary implementations.

FIG. 2 is a functional block diagram of a wireless power transfer system, in accordance with some other exemplary implementations.

FIG. 3 is a schematic diagram of a portion of transmit circuitry or receive circuitry of FIG. 2 including a transmit or receive coil, in accordance with some exemplary implementations.

FIG. 4 is an illustration of a wireless power transmitter, a wireless power receiver, and a wireless power adapter, in accordance with some implementations.

FIG. 5 is an illustration of a DC coupled wireless power adapter, in accordance with some implementations.

FIG. 6 is an illustration of an AC coupled wireless power adapter, in accordance with some implementations.

FIG. 7 illustrates an input waveform and an output waveform of the synchronous rectifier circuit of the AC coupled wireless power adapter of FIG. 6 for a high to low frequency conversion, in accordance with some implementations.

FIG. 8 illustrates an input waveform and an output waveform of the AC coupled wireless power adapter of FIG. 6 for a low to high frequency conversion, in accordance with some implementations.

FIG. 9 is a flowchart depicting a method for wireless power transfer, in accordance with some exemplary implementations.

### DETAILED DESCRIPTION

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured, or coupled by a “receive coil” to achieve power transfer.

The terminology used herein is for the purpose of describing particular implementations only and is not intended to be limiting on the disclosure. It will be understood that if a specific number of a claim element is intended, such intent will be explicitly recited in the claim, and in the absence of such recitation, no such intent is present. For example, as used herein, the singular forms “a,” “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

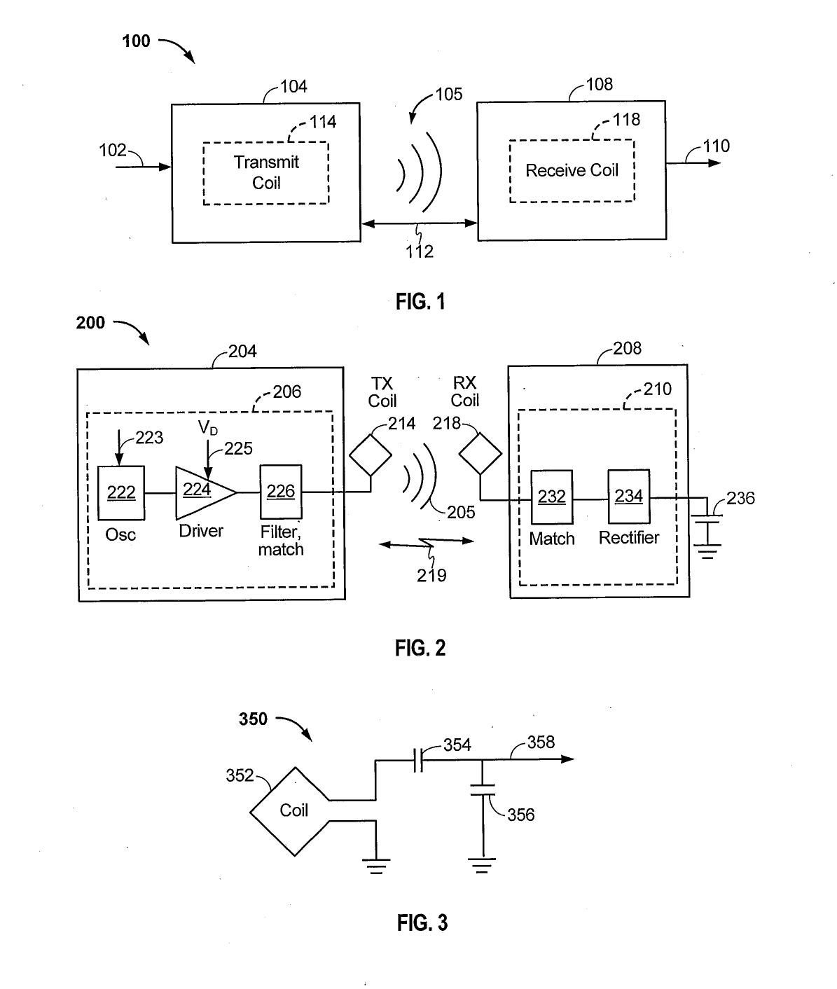

FIG. 1 is a functional block diagram of a wireless power transfer system 100, in accordance with some exemplary implementations. Input power 102 may be provided to a transmitter 104 from a power source (not shown) to generate a wireless (e.g., magnetic or electromagnetic) field 105 via a transmit coil 114 for performing energy transfer. The receiver 108 may receive power when the receiver 108 is located in the wireless field 105 produced by the transmitter 104. The wireless field 105 corresponds to a region where energy output by the transmitter 104 may be captured by the receiver 108. A receiver 108 may couple to the wireless field 105 and generate output power 110 for storing or consumption by a device (not shown in this figure) coupled to the output power 110. Both the transmitter 104 and the receiver 108 are separated by a distance 112.

In one example implementation, power is transferred inductively via a time-varying magnetic field generated by the transmit coil 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are minimal. However, even when resonance between the transmitter 104 and receiver 108 are not matched, energy may be transferred, although the efficiency may be reduced. For example, the efficiency may be less when resonance is not matched. Transfer of energy occurs by coupling energy from the wireless field 105 of the transmit coil 114 to the receive coil 118, residing in the vicinity of the wireless field 105, rather than propagating the energy from the transmit coil 114 into free space. Resonant inductive coupling techniques may thus allow for improved efficiency and power transfer over various distances and with a variety of inductive coil configurations.

In some implementations, the wireless field 105 corresponds to the “near-field” of the transmitter 104. The near-field may correspond to a region in which there are strong reactive fields resulting from the currents and charges in the transmit coil 114 that minimally radiate power away from the transmit coil 114. The near-field may correspond to a region that is within about one wavelength (or a fraction thereof) of the transmit coil 114. Efficient energy transfer may occur by coupling a large portion of the energy in the wireless field 105 to the receive coil 118 rather than propagating most of the energy in an electromagnetic wave to the far field. When positioned within the wireless field 105, a “coupling mode” may be developed between the transmit coil 114 and the receive coil 118.

FIG. 2 is a functional block diagram of a wireless power transfer system 200, in accordance with some other exemplary implementations. The system 200 may be a wireless power transfer system of similar operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that may be adjusted in response to a frequency control signal 223. The oscillator 222 provides the oscillator signal to the driver circuit 224. The driver circuit 224 may be configured to drive the transmit coil 214 at a resonant frequency of the transmit coil 214 based on an input voltage signal (V_{D}) 225.

The filter and matching circuit 226 filters out harmonics or other unwanted frequencies and matches the impedance of the transmit circuitry 206 to the transmit coil 214. As a result of driving the transmit coil 214, the transmit coil 214 generates a wireless field 205 to wirelessly output power at a level sufficient for charging a battery 236.

The receiver 208 comprises receive circuitry 210 that includes a matching circuit 232 and a rectifier circuit 234. The matching circuit 232 may match the impedance of the receive circuitry 210 to the impedance of the receive coil 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205. In some implementations, the receiver 208 may be configured to determine whether an amount of power transmitted by the transmitter 204 and received by the receiver 208 is appropriate for charging the battery 236.

FIG. 3 is a schematic diagram of a portion of the transmit circuitry 206 or the receive circuitry 210 of FIG. 2, in accordance with some exemplary implementations. As illustrated in FIG. 3, transmit or receive circuitry 350 may include a coil 352. The coil 352 may also be referred to or be configured as a “conductor loop”, an inductor, an antenna, or a “magnetic” coil.

The resonant frequency of the loop or magnetic coils is based on the inductance and capacitance of the loop or magnetic coil. Inductance may be simply the inductance created by the coil 352, whereas, capacitance may be added via a capacitor (or the self-capacitance of the coil 352) to create a resonant structure at a desired resonant frequency. As a non-limiting example, a capacitor 354 and a capacitor 356 may be added to the transmit or receive circuitry 350 to create a resonant circuit that resonates at a resonant frequency. For larger sized coils using large diameter coils exhibiting larger inductance, the value of capacitance needed to produce resonance may be lower. Furthermore, as the size of the coil increases, coupling efficiency may increase. This is mainly true if the size of both base and electric vehicle coils increase. For transmit coils, the signal 358, with a frequency that substantially corresponds to the resonant frequency of the coil 352, may be an input to the coil 352. For receive coils, the signal 358 may be the output from the coil 352.

More than one wireless power protocol has evolved. For example, wireless power protocols include non-resonant inductive charging, resonant inductive charging, tightly coupled transmit and receive coils, loosely coupled transmit and receive coils, varied frequencies of operation, varying alignment tolerances, varying communication types including in-band and out-of-band signaling, as well as varying methods of power control. This means that while interoperability between two devices using the same protocol is ensured, operation between different wireless power protocols is not. Differences in frequency, signaling, timing and magnetic field strength virtually guarantee that a device from one protocol will not interoperate with a device from a second protocol. This means that a user with one protocol may not be able to use wireless charging if he or she only has access to a charger that uses a different wireless power protocol than the chargeable device. This is inconvenient and will limit how rapidly wireless power as a whole may be adopted.

The present application contemplates an “adapter pad” that converts one wireless power protocol into a second wireless power protocol, allowing a chargeable device to be used with more than one wireless power protocol.

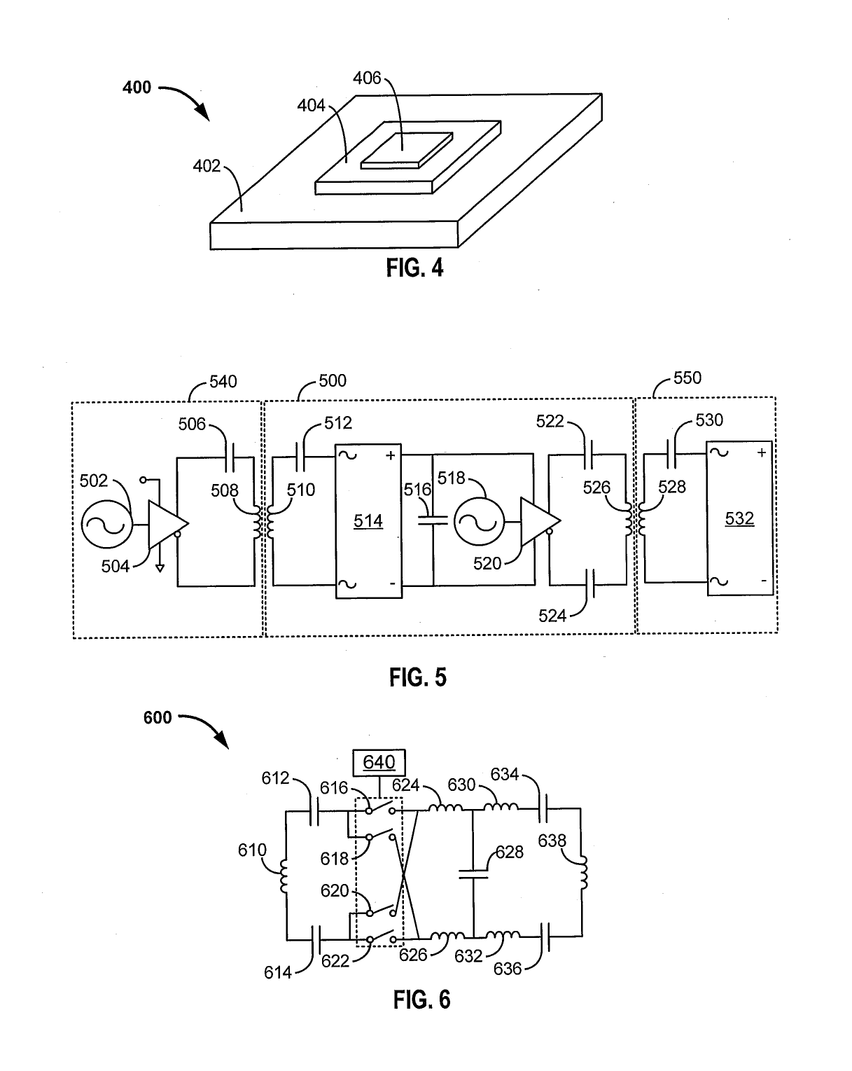

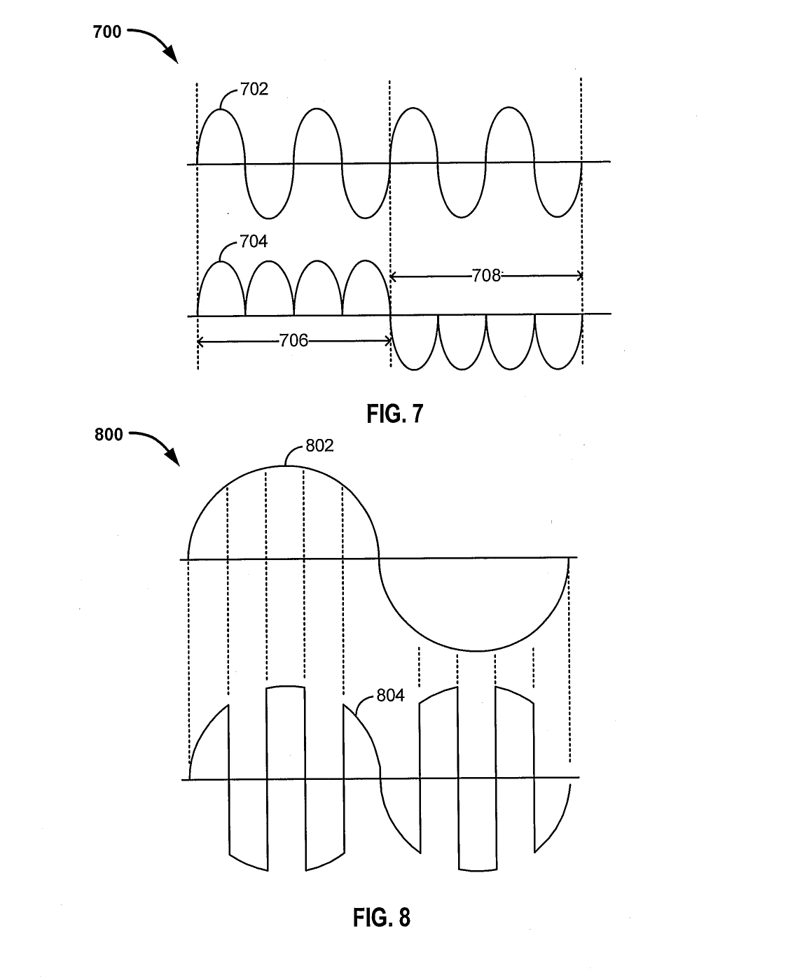

FIG. 4 is an illustration 400 of a wireless power transmitter 402, a wireless power receiver 406, and a wireless power adapter 404, in accordance with some implementations. In some implementations, the wireless power transmitter 402 may comprise a loosely coupled transmitter and the wireless power receiver 406 may comprise a tightly coupled chargeable device. In some implementations, the wireless power adapter 404 may receive wireless power transmitted according to a first wireless power protocol from the wireless power transmitter 402 and may transmit wireless power according to a second wireless power protocol to the wireless power receiver 406. In some implementations, the wireless power adapter 404 may comprise a DC coupled device, as will be described in connection with FIG. 5, or an AC coupled device, as will be described in connection with FIGS. 6-8.

FIG. 5 is an illustration of a DC coupled wireless power adapter 500, in accordance with some implementations. The DC coupled wireless power adapter 500 may comprise a complete receiver (e.g., receive coil 510, capacitor 512, rectifier circuit 514 and optionally smoothing capacitor 516) configured to receive power from a wireless power transmitter 540 (e.g., oscillator 502, driver circuit 504, capacitor 506 and transmit coil 508) according to a first wireless power protocol and output a DC voltage. The DC coupled wireless power adapter 500 additionally includes all power, control and communication circuitry (not shown) required to receive power according to at least the first wireless power protocol. Thus, the DC coupled wireless power adapter 500 may appear to the wireless power transmitter 540 as an ordinary device to be charged. The DC coupled wireless power adapter 500 additionally comprises a transmitter (e.g., oscillator 518, driver circuit 520, capacitors 522, 524 and transmit coil 526) that receives the DC power and uses it to drive its transmitter according to a second wireless power protocol. Again, the DC coupled wireless power adapter 500 additionally includes all power, control and communication circuitry (not shown) required to wirelessly transmit power according to at least the second wireless power protocol.

As shown in FIG. 5, the wireless power transmitter 540 may correspond to the wireless power transmitter 402 of FIG. 4 and may comprise an oscillator 502 configured to generate an input signal to a driver circuit 504. The driver circuit 504 may be configured to drive an alternating signal through a capacitor 506 and a transmit coil 508 (e.g., an inductor) according to a first wireless power protocol to generate a first alternating magnetic field.

The adapter 500 may correspond to the wireless power adapter 404 of FIG. 4 and may comprise a receive coil 510, configured to generate a voltage under influence of the first alternating magnetic field, and a capacitor 512. The series connection of the receive coil 510 and the capacitor 512 may be connected across the inputs of a rectifier circuit 514, which may output DC power at the (+) and (−) terminals. A capacitor 516 connected across the output terminals of the rectifier circuit 514 may smooth the DC power, which may be provided to a driver circuit 520. An oscillator 518 may be configured to generate an input signal to the driver circuit 520. The driver circuit 520 may be configured to drive an alternating signal through the capacitors 522, 524 and a transmit coil 526 (e.g., an inductor) according to a second wireless power protocol to generate a second alternating magnetic field.

The wireless power receiver 550 may correspond to the wireless power receiver 406 of FIG. 4 and may comprise a receive coil 528 configured to generate a signal under influence of the second alternating magnetic field, and a capacitor 530. The series connected receive coil 528 and capacitor 530 may be connected across the input terminals of a rectifier circuit 532, which may output DC power for the wireless power receiver 550 to use for operation and/or charging purposes. The DC coupled adapter 500 may further comprise a processor or controller 555 configured to control the operation of the rectifier circuit 514 as well as any communication, in band or out of band, with either or both of the wireless power transmitter 540 and the wireless power receiver 550 related to the setup, operation, or teardown of a wireless power transfer session. For example, the controller 555 may be configured to coordinate different wireless power protocols between the wireless power transmitter 540 and the DC coupled adapter 500 and between the DC coupled adapter 500 and the wireless power receiver 550. Such different wireless power protocols may include non-resonant inductive charging, resonant inductive charging, tightly coupled transmit and receive coils, loosely coupled transmit and receive coils, varied frequencies of operation, varying alignment tolerances, varying communication types including in-band and out-of-band signaling, as well as varying methods of power control. Specifically, in some implementations, the receive coil 510 may be configured to receive wireless power from the wireless power transmitter 540 via resonant magnetic induction and the transmit coil 526 may be configured to transmit wireless power to the wireless power receiver 550 via non-resonant magnetic induction. In some other implementations, the receive coil 510 may be configured to receive wireless power from the wireless power transmitter 540 via non-resonant magnetic induction and the transmit coil 526 may be configured to transmit wireless power to the wireless power receiver 550 via resonant magnetic induction. Although FIG. 5 illustrates a series tuned transmitter and receiver, the transmitter or the receiver may be either series or shunt (e.g., parallel) tuned.

An AC coupled adapter, as shown in FIG. 6, may address some of the deficiencies of DC coupled adapters (e.g., relating to complexity, cost, conversion losses from AC to DC and back to AC). FIG. 6 is an illustration of an AC coupled wireless power adapter 600, in accordance with some implementations. The AC coupled adapter 600 may comprise a receive coil 610 and capacitors 612, 614, connected in series with the receive coil 610, configured to generate a signal under influence of an alternating magnetic field generated by a wireless power transmitter according to a first wireless power protocol. The series connected receive coil 610 and capacitors 612, 614 are connected across the input terminals of a synchronous rectifier circuit (shown as the dotted lined box) comprising a first switch 616, a second switch 618, a third switch 620 and a fourth switch 622. Within the synchronous rectifier circuit, the first switch 616 is configurable to connect a first input terminal to a first output terminal. The second switch 618 is configurable to connect the first input terminal to a second output terminal. The third switch 620 is configurable to connect a second input terminal to the first output terminal. And the fourth switch 622 is configurable to connect the second input terminal to the second output terminal. In some implementations, the first switch 616 and the second switch 618 may be substituted for a single switch configured to connect the first input terminal to either the first output terminal or the second output terminal. Likewise, the third switch 620 and the fourth switch 622 may be substituted for a single switch configured to connect the second input terminal to either the first output terminal or the second output terminal. In some implementations, the first output terminal of the synchronous rectifier circuit is connected in series with an inductor 624, an inductor 630 and a capacitor 634. Likewise, the second output terminal of the synchronous rectifier circuit is connected in series with an inductor 626, an inductor 632 and a capacitor 636. A capacitor 628 may be connected between a node connecting the inductor 624 to the inductor 630 and a node connecting the inductor 626 to the inductor 632. A transmit coil 638 is connected in series with the capacitor 634 and the capacitor 636. The AC coupled adapter 600 may further comprise a processor or controller 640 configured to control the operation of the synchronous rectifier circuit (dotted line) as well as any communication, in band or out of band, with either or both of the wireless power transmitter and the wireless power receiver related to the setup, operation, or teardown of a wireless power transfer session.

In the design of FIG. 6, the synchronous rectifier circuit is used to produce a signal having a lower or higher frequency across its output terminals than the signal received across its input terminals. The synchronous rectifier circuit is driven by the controller 640 and either rectifies a given number of cycles of the input AC signal to DC and then reverses the rectification polarity to achieve a lower frequency signal across its output terminals, or chops the input AC signal to achieve a higher frequency signal across its output terminals. This design (FIG. 6) is inherently bidirectional, which means it is configurable to convert power in either direction. Although FIG. 6 illustrates a series tuned transmitter (e.g., series connected capacitors 624, 636 and transmit coil 638) and receiver (e.g., series connected capacitors 612, 614 and receive coil 610), the transmitter or the receiver may be either series or shunt (e.g., parallel) tuned.

FIG. 7 illustrates an input waveform 702 and an output waveform 704 of the synchronous rectifier circuit of the AC coupled wireless power adapter 600 of FIG. 6 for a high to low frequency conversion, in accordance with some implementations. The input waveform 702 may be applied across the input terminals of the synchronous rectifier circuit of the AC coupled wireless power adapter 600, while the output waveform 704 may be produced across the output terminals of the synchronous rectifier circuit of the AC coupled wireless power adapter 600. As shown, the synchronous rectifier circuit of the AC coupled wireless power adapter 600 is configured to toggle a polarity of rectification between a first polarity and a second polarity opposite of the first polarity at the second frequency (e.g., the frequency of the output waveform 704) such that a first plurality (e.g., a first whole number) of consecutive half cycles 706 of the wireless power received by the receive coil 610 are rectified with the first polarity and a second plurality (e.g., a second whole number) of consecutive half cycles 706, 708 of the wireless power received by the receive coil 610 are rectified with the second polarity to produce the output waveform 704. As shown, the first plurality or whole number of consecutive half cycles 706 may be immediately followed by the second plurality or whole number of consecutive half cycles 708, and may repeat. As an example, the input waveform 702 has four times the frequency of the output waveform 704. Thus, FIG. 7 illustrates a high to low frequency conversion. Such a procedure is most efficient when the high to low conversion is an integer multiple, e.g., 4 in this example, since each half wavelength of the input waveform 702 is rectified with the same polarity across the entire half wavelength. Thus, an example input signal having frequency of 6.78 MHz could be converted to an output signal having a frequency of 150.66 kHz utilizing 45 to 1 frequency conversion. The output waveform 704 includes significant harmonic content, which may be attenuated utilizing one or more filters, e.g., a low pass filter.

FIG. 8 illustrates an input waveform 802 and an output waveform 804 of the AC coupled wireless power adapter 600 of FIG. 6 for a low to high frequency conversion, in accordance with some implementations. The input waveform 802 may be applied across the input terminals of the synchronous rectifier circuit of the AC coupled wireless power adapter 600, while the output waveform 804 may be produced across the output terminals of the synchronous rectifier circuit of the AC coupled wireless power adapter 600. As shown, the input waveform 802 is chopped by toggling the synchronous rectifier switches 616, 618, 620, 622 at a rate faster than the frequency of the input waveform 802. Each dotted line in FIG. 8 may indicate a toggling of the switches 616, 618, 620, 622. As an example, the output waveform 804 has five times the frequency of the input waveform 802. Thus, the synchronous rectifier circuit of the AC coupled wireless power adapter 600 may be configured to toggle a polarity of rectification between a first polarity and a second polarity opposite of the first polarity such that an output of the rectifier circuit flips polarity a whole number of times during, each half cycle of the wireless power received by the receive coil 610. Accordingly, FIG. 8 illustrates a low to high frequency conversion. The output waveform 804 includes significant harmonic content, which may be attenuated utilizing one or more filters, e.g., a low pass filter.

The AC coupled wireless power adapter 600 may provide higher efficiency in some aspects than the DC coupled wireless power adapter 500 since there is no AC to DC conversion. The AC coupled wireless power adapter 600 may include control circuitry to drive the synchronous rectifier circuit to have particular timing and synchronization requirements.

Control systems for either the DC coupled wireless power adapter 500 or the AC coupled wireless power adapter 600 may include local control for driving the synchronous rectifiers, or monitor temperature, voltages and/or currents within the adapter and may additionally include link protocol communication and control based on the wireless power protocols at which the adapters receive and transmit wireless power.

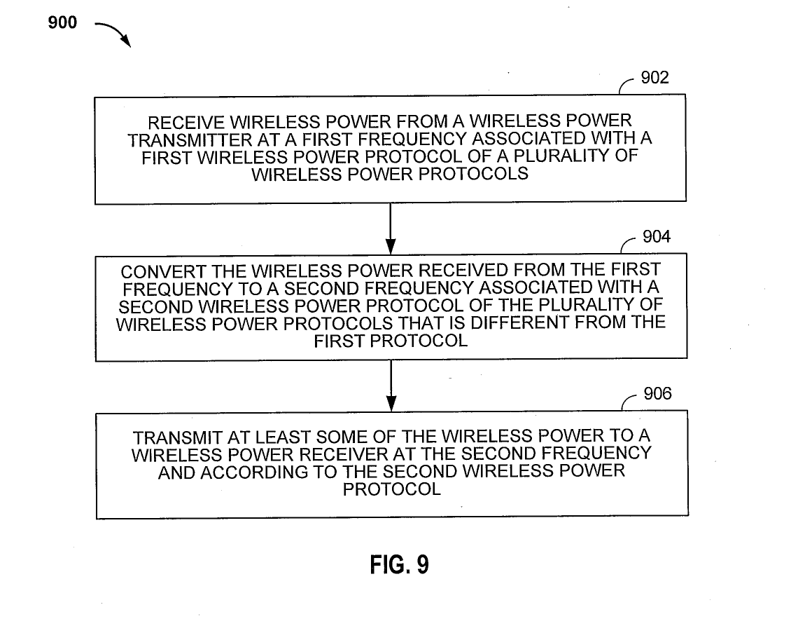

FIG. 9 is a flowchart depicting a method for wireless power transfer, in accordance with some exemplary implementations. The flowchart 900 is described herein with reference to any of FIGS. 4-8. Although the flowchart 900 is described herein with reference to a particular order, in various implementations, blocks herein may be performed in a different order, or omitted, and additional blocks may be added.

Block 902 includes receiving wireless power from a wireless power transmitter at a first frequency associated with a first wireless power protocol of a plurality of wireless power protocols. For example, as previously described in connection with FIGS. 4 and 6-8, the wireless power transfer adapter 600 may comprise a receive coil 610 configured to receive wireless power from a wireless power transmitter at a first frequency associated with a first wireless power protocol of a plurality of wireless power protocols. In some implementations, the receive coil 610 is configured to receive the wireless power from the wireless power transmitter via magnetic induction. In some implementations, the receive coil 610 may also be known as, or comprise at least a portion of “means for receiving wireless power from a wireless power transmitter at a first frequency associated with a first wireless power protocol of a plurality of wireless power protocols.”

Block 904 includes converting the wireless power received from the first frequency to a second frequency associated with a second wireless power protocol of the plurality of wireless power protocols that is different from the first protocol. For example, as previously described in connection with FIGS. 4 and 6-8, the wireless power transfer adapter 600 comprises a rectifier circuit (e.g., within the dotted line box) configured to convert the wireless power received by the receive coil 610 from the first frequency to a second frequency associated with a second wireless power protocol of the plurality of wireless power protocols. In some implementations, the synchronous rectifier circuit (e.g., within the dotted line box) may also be known as, or comprise at least a portion of “means for converting the wireless power received from the wireless power transmitter from the first frequency to a second frequency associated with a second wireless power protocol of the plurality of wireless power protocols.”

Block 906 includes transmitting at least some of the wireless power to a wireless power receiver at the second frequency and according to the second wireless power protocol. For example, as previously described in connection with FIGS. 4 and 6-8, the wireless power transfer adapter 600 may comprise a transmit coil 638 configured to transmit at least some of the wireless power to a wireless power receiver 406 (see FIG. 4) at the second frequency and according to the second wireless power protocol. In some implementations, the transmit coil 638 is configured to transmit the at least some of the wireless power to the wireless power receiver 406 via magnetic induction. In some implementations, the transmit coil 638 may also be known as, or comprise at least a portion of “means for transmitting at least some of the wireless power to a wireless power receiver at the second frequency and according to the second wireless power protocol.”

In some implementations, the first frequency is higher than the second frequency. In some implementations, the first frequency is lower than the second frequency. In some implementations, the flowchart 900 may additionally include toggling a polarity of rectification between a first polarity and a second polarity opposite of the first polarity at the second frequency such that a first plurality of consecutive half cycles of the wireless power received from the wireless power transmitter are rectified with the first polarity and a second plurality of consecutive half cycles of the wireless power received from the wireless power transmitter are rectified with the second polarity (see FIG. 7). Such an action may be performed by the synchronous rectifier circuit (see dotted line box in FIG. 6), which in some implementations, may also be known as, or comprise at least a portion of “means for toggling a polarity of rectification between a first polarity and a second polarity opposite of the first polarity at the second frequency.”

In some implementations, the flowchart 900 may additionally include toggling a polarity of rectification between a first polarity and a second polarity opposite of the first polarity at the second frequency such that any half cycle of the wireless power received from the wireless power transmitter is rectified with each of the first polarity and the second polarity at least once (see FIG. 8). Such an action may be performed by the synchronous rectifier circuit (see dotted line box in FIG. 6).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, one or more implementations achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. A wireless power transfer adapter, comprising:
a receive coil configured to receive wireless power from a wireless power transmitter at a first frequency associated with a first wireless power protocol of a plurality of wireless power protocols;
a rectifier circuit configured to convert the wireless power received by the receive coil from the first frequency to a second frequency associated with a second wireless power protocol of the plurality of wireless power protocols that is different from the first protocol; and
a transmit coil configured to transmit at least some of the wireless power to a wireless power receiver at the second frequency and according to the second wireless power protocol.

2. The wireless power transfer adapter of claim 1, wherein the rectifier circuit is configured to toggle a polarity of rectification between a first polarity and a second polarity opposite of the first polarity at the second frequency such that a first plurality of consecutive half cycles of the wireless power received by the receive coil are rectified with the first polarity and a second plurality of consecutive half cycles of the wireless power received by the receive coil are rectified with the second polarity.

3. The wireless power transfer adapter of claim 1, wherein the rectifier circuit is configured to:
rectify a first whole number of consecutive half cycles of the wireless power received by the receive coil to each have a first polarity; and
rectify a second whole number of consecutive half cycles of the wireless power received by the receive coil to each have a second polarity opposite of the first polarity.

4. The wireless power transfer adapter of claim 1, wherein the rectifier circuit is configured to toggle a polarity of rectification between a first polarity and a second polarity opposite of the first polarity at the second frequency such that any half cycle of the wireless power received by the receive coil is rectified with each of the first polarity and the second polarity at least once.

5. The wireless power transfer adapter of claim 1, wherein the rectifier circuit is configured to toggle a polarity of rectification between a first polarity and a second polarity opposite of the first polarity such that an output of the rectifier circuit flips polarity a whole number of times during each half cycle of the wireless power received by the receive coil.

6. The wireless power transfer adapter of claim 1, wherein the rectifier circuit comprises:
at least one switch configured to connect a first input of the rectifier circuit to either of a first output of the rectifier circuit and a second output of the rectifier circuit; and
at least one other switch configured to connect a second input of the rectifier circuit to either of the first output of the rectifier circuit and the second output of the rectifier circuit.

7. The wireless power transfer adapter of claim 1, further comprising:
a first inductor and a second inductor connected in series to a first output of the rectifier circuit;
a third inductor and a fourth inductor connected in series to a second output of the rectifier circuit; and
a capacitor connected between a first node connecting the first inductor to the second inductor and a second node connecting the third indictor to the fourth inductor.

8. The wireless power transfer adapter of claim 1, wherein the receive coil is configured to receive the wireless power from the wireless power transmitter via resonant magnetic induction and the transmit coil is configured to transmit the at least some of the wireless power to the wireless power receiver via non-resonant magnetic induction.

9. The wireless power transfer adapter of claim 1, wherein the receive coil is configured to receive the wireless power from the wireless power transmitter via non-resonant magnetic induction and the transmit coil is configured to transmit the at least some of the wireless power to the wireless power receiver via resonant magnetic induction.

10. The wireless power transfer adapter of claim 1, wherein the first frequency is higher than the second frequency.

11. The wireless power transfer adapter of claim 1, wherein the first frequency is lower than the second frequency.

12. A method for wireless power transfer, comprising:
receiving wireless power from a wireless power transmitter at a first frequency associated with a first wireless power protocol of a plurality of wireless power protocols;
converting the wireless power received from the first frequency to a second frequency associated with a second wireless power protocol of the plurality of wireless power protocols that is different from the first protocol; and
transmitting at least some of the wireless power to a wireless power receiver at the second frequency and according to the second wireless power protocol.

13. The method of claim 12, further comprising toggling a polarity of rectification between a first polarity and a second polarity opposite of the first polarity at the second frequency such that a first plurality of consecutive half cycles of the wireless power received from the wireless power transmitter are rectified with the first polarity and a second plurality of consecutive half cycles of the wireless power received from the wireless power transmitter are rectified with the second polarity.

14. The method of claim 12, further comprising:
rectifying a first whole number of consecutive half cycles of the wireless power received from the wireless power transmitter to each have a first polarity; and
rectifying a second whole number of consecutive half cycles of the wireless power received from the wireless power transmitter to each have a second polarity opposite of the first polarity.

15. The method of claim 12, further comprising toggling a polarity of rectification between a first polarity and a second polarity opposite of the first polarity at the second frequency such that any half cycle of the wireless power received from the wireless power transmitter is rectified with each of the first polarity and the second polarity at least once.

16. The method of claim 12, further comprising toggling a polarity of rectification between a first polarity and a second polarity opposite of the first polarity such that a polarity of the converted wireless power is flipped a whole number of times during each half cycle of the wireless power received from the wireless power transmitter.

17. The method of claim 12, wherein receiving the wireless power from the wireless power transmitter is performed via resonant magnetic induction and transmitting the at least some of the wireless power is to the wireless power receiver is performed via non-resonant magnetic induction.

18. The method of claim 12, wherein receiving the wireless power from the wireless power transmitter is performed via non-resonant magnetic induction and transmitting the at least some of the wireless power to the wireless power receiver is performed via resonant magnetic induction.

19. The method of claim 12, wherein the first frequency is higher than the second frequency.

20. The method of claim 12, wherein the first frequency is lower than the second frequency.

21. A wireless power transfer adapter, comprising:
means for receiving wireless power from a wireless power transmitter at a first frequency associated with a first wireless power protocol of a plurality of wireless power protocols;
means for converting the wireless power received from the wireless power transmitter from the first frequency to a second frequency associated with a second wireless power protocol of the plurality of wireless power protocols that is different from the first protocol; and
means for transmitting at least some of the wireless power to a wireless power receiver at the second frequency and according to the second wireless power protocol.

22. The wireless power transfer adapter of claim 21, further comprising means for toggling a polarity of rectification between a first polarity and a second polarity opposite of the first polarity at the second frequency such that a first plurality of consecutive half cycles of the wireless power received from the wireless power transmitter are rectified with the first polarity and a second plurality of consecutive half cycles of the wireless power received from the wireless power transmitter are rectified with the second polarity.

23. The wireless power transfer adapter of claim 21, further comprising:
means for rectifying a first whole number of consecutive half cycles of the wireless power received by the means for receiving wireless power to each have a first polarity; and
means for rectifying a second whole number of consecutive half cycles of the wireless power received by the means for receiving wireless power to each have a second polarity opposite of the first polarity.

24. The wireless power transfer adapter of claim 21, further comprising means for toggling a polarity of rectification between a first polarity and a second polarity opposite of the first polarity at the second frequency such that any half cycle of the wireless power received from the wireless power transmitter is rectified with each of the first polarity and the second polarity at least once.

25. The wireless power transfer adapter of claim 21, further comprising
means for toggling a polarity of rectification between a first polarity and a second polarity opposite of the first polarity such that an output of the means for converting the wireless power flips polarity a whole number of times during each half cycle of the wireless power received by the means for receiving wireless power.

26. The wireless power transfer adapter of claim 21, wherein the means for converting the wireless power received from the wireless power transmitter comprises:
at least one switch configured to connect a first input of the means for converting to either of a first output of the means for converting and a second output of the means for converting; and
at least one other switch configured to connect a second input of the means for converting to either of the first output of the means for converting and the second output of the means for converting.

27. The wireless power transfer adapter of claim 21, wherein the means for receiving wireless power from the wireless power transmitter receives the wireless power via resonant magnetic induction and the means for transmitting the at least some of the wireless power to the wireless power receiver is configured to transmit the at least some of the wireless power to the wireless power receiver via non-resonant magnetic induction.

28. The wireless power transfer adapter of claim 21, wherein the means for receiving wireless power from the wireless power transmitter is configured to receive the wireless power from the wireless power transmitter via non-resonant magnetic induction and the means for transmitting the at least some of the wireless power to the wireless power receiver transmits the at least some of the wireless power via resonant magnetic induction.

29. The wireless power transfer adapter of claim 21, wherein the first frequency is higher than the second frequency.

30. The wireless power transfer adapter of claim 21, wherein the first frequency is lower than the second frequency.
